(19) United States
(12) Patent Application Publication
(10) Pub. No.: US 2005/0220957 A1
(43) Pub. Date: Oct. 6, 2005

(54) Tomato process

(75) Inventors: Sheila Marie Winship, Monroe, NY (US); Roland Bauer, West Milford, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 10/813,514

(22) Filed: Mar. 30, 2004

(51) Int. Cl. A23K 1/00

(52) U.S. Cl. 426/518

(57) ABSTRACT

A split stream method for processing tomatoes. The benefits of split stream processing can be more fully realized when the split streams are re-combined under specific processing conditions. In particular, under specified conditions of shear and heat, the potential viscosity of the thick stream is fully harvested. The amount of shear used in accordance with the invention is significantly greater than the amount required to reconstitute at least some prior pastes.

### BACKGROUND OF THE INVENTION

Interest among consumers in tomato-based sauces is often high due to the many types of delicious foods in which they can be used. Tomato products tend particularly to be appreciated for their flavors. As a general rule, however, heating of a tomato product tends somewhat to diminish its flavor. Therefore, manufacturers of tomato products have attempted to develop processes which minimize any unfavorable impact on flavor.

The possibility of split stream processing has been explored in efforts to improve flavor. By splitting the stream of tomato product into two substreams, a “thin” soluble solids-containing substream and a “thick” insoluble solids containing substream, it has been thought that heating conditions of the individual substreams could be tailored to their separate needs, so that overheating of individual components would be minimized. Other reasons for split stream processing include the desire to isolate individual components for use as food ingredients.

Succar et al., WO03/024243 is directed to a processing method and system for producing tomato paste and other food products. Tomatoes are processed into tomato juice which is then decanted to separate the juice into two portions—a thicker, more viscous cake portion and a thinner, less viscous serum portion. The serum portion is concentrated by removing a portion of water using an evaporator such as a thin film or juice evaporator. The cake portion can be concentrated, if desired, with a drier. The serum and cake portions are recombined to produce a tomato paste having improved color, texture, flavor and nutrition. Re-combining can be performed using a combiner or combination unit. Examples include a positive displacement pump and an in-line static mixer. Enzyme breaking can occur at cold (150 to 170° F.) or hot (200 to 230° F.) temperatures. Pulping-finishing occurs at approximately 190-210° F. where hot breaking was employed and approximately 150 to l7° F. where cold breaking was utilized.

Raya et al., EP 888 718 is directed to a process for preparing tomato-based products comprising 1) heating raw tomatoes (e.g., at 65 to 90° C. for cold break or above 90° C. for hot break) for a sufficient time to inactivate the enzymes, 2) separating from the heated tomatoes a juice and a slurry containing seeds and peels, 3) separating the seeds and peels from the slurry, 4) finely dividing the separated slurry and 5) reincorporating the divided slurry into the juice. The invention also relates to a tomato-based product obtainable from steps 1 to 4.

Yoshitaka, et al., JP03240469 relates to preparing a juice free from any heating odor by diluting the vacuum-concentrated product of a tomato juice with water, separating the diluted juice into a pulp portion and a serum portion, bringing the serum portion into contact with a synthetic adsorbing resin, separating the serum portion from the resin, and subsequently combining the separated serum potion with the original pulp portion. Separation into a pulp portion and a serum portion is preferably carried out using a centrifugal separation method. The synthetic absorbing resin is preferably a resin prepared by immobilizing cyclodextrin on the surface of a granular synthetic resin. The serum portion separated from the resin is combined with the original pulp portion to provide the juice.

Mitchell et al., U.S. Pat. No. 4,031,266 is directed to dehydrated reconstitutable tomato beverage compositions prepared by forming an aqueous mixture of tomato solids and gelatinizable starch materials, the ratio of starch materials to water in the admixture being such that limited rupture of the starch granules occurs, whereupon the admixture is drum dried and ground to produce a powder. Preferred temperatures for drum drying are 150 to 170° C. Upon rehydration, the powder gives tomato beverages of viscosity, texture and taste which are said to be comparable to conventional non-dehydrated tomato beverages.

Hartal, et al., WO 02/21935 is directed to a composition obtained from tomato pulp which includes dietary fibers with high water binding capacity. The composition can be used as a texturizing, bulking, viscosity controlling or syneresis-preventing agent for food. The product is made by extracting carotenoids and lipids from a fine pulp. Fine crushed tomatoes are heated to 80-110° C. and then separated to serum and fine pulp.

Lang, U.S. Pat. No. 5,229,160 discloses that tomatoes and other fruit may be processed so as to avoid destroying viscosity inducing components by passing the sliced fruit through a counter current extractor in counter current with an aqueous liquid, the liquid being heated to a temperature such that the fruit slices are heated to at least 65° C., recovering a liquid phase from the lower end of the extractor and a solid phase from the upper end and recovering flavor and/or aroma components from the liquid phase.

Becker. U.S. Pat. No. 3,976,805 is directed to tomato products of increased consistency prepared by sequentially acidifying and homogenizing juices or concentrates. The juice is homogenized by application of vigorous and repeated shearing action. By such treatment, fruit cells suspended in the juice are deliberately damaged—ruptured, shredded, sheared, or otherwise mechanically injured—with the end result that the juice is increased in consistency. It is said that various types of equipment can be used to carry out homogenization, such as Waring Blenders, Osterizers or the like. Homogenizers which force juice under high pressure through a small orifice, colloid mills and sonifiers are also mentioned. It is said that other methods for accomplishing the homogenization operation will be evident to those of ordinary skill. The time and intensity of the homogenization is said to depend on such factors as type of equipment and degree of consistency increase required.

The Becker process is said to produce a high-consistency juice which can be blended with conventional juices (ones of lower consistency). The process of the invention is said readily to yield increases in consistency of from 300 to 1000% or more whereas the inventor's observation for homogenization alone applied to tomato juice or concentrates is said usually to result in a thinning of the product or in a rare cases a consistency increase by a small degree, e.g., about 50-75%. In the examples, the blender used for homogenization was operated at high speed to attain vigorous and repeated shearing action.

Zelkha et al., WO 97/48287 is directed to a process for manufacturing tomato products which comprises pretreating the tomatoes, as by crushing, subjecting to a heat treatment, separating the crushed tomatoes into serum and pulp containing at least 500 ppm of lycopene, subjecting the pulp to solvent extraction, to extract an oleoresin containing lycopene, separating the spent pulp, and separating the lycopene extract from the solvents whereby to obtain oleoresin containing the lycopene and to recover the solvents. In a variant of the invention, a material chosen from among dehydrated tomato pulp, dispersing agents or carriers, such as maltodextrins, starches, etc. can be added to concentrated serum. In one of the examples, a mixture of serum concentrate and tomato juice is spray dried. The separation should be carried out at between 75° C. and 110° C.; extraction should be effected at from 40 to 75° C. Miller, U.S. Pat. No. 3,172,770 is directed to a process for preparing a tomato concentrate. A centrifugal separator separates tomato juice into a substantially insoluble fraction and a substantially soluble fraction. Later these may be recombined.

Szabo et al., U.S. Pat. No. 3,864,504 is directed to a process wherein tomatoes are triturated and the colloids are coagulated with calcium chloride. The serum and coagulum are separated and separately concentrated by evaporation and then recombined. The unification of the serum with the filtered out colloids can be performed in simple mixing equipment. In column 4, the serum fraction is described as being homogenized with the colloid fraction.

While clearly some work has been done on split stream processing, it has yet to live up to its perceived potential. One disappointment concerns the difficulty in recombining the substreams into a single integral stream of product having the required consistency.

Todd, U.S. Pat. No. 2,723,199 is directed to a process for dehydrating and freezing pimientos and peppers wherein the meat and juice are separated in a vacuum concentrator. Concentrated juice from the concentrator is later sprayed onto the dehydrated meats.

Zelkha et al., WO 95/16363 is directed to a process for manufacturing tomato products which includes separating the serum from the pulp.

Geifman et al., WO 99/60868 is directed to a taste enhancer comprising clear tomato concentrate. An objective is to afford a taste enhancer which lacks the dominant tomato flavor so that it can be used in a variety of savory food and beverage products, and not just those based taste on tomatoes. In examples the taste enhancer is added to hamburger, paolla rice and vegetable soup. The taste enhancer includes hydrolyzed proteins from a tomato serum.

Bueno et al., WO 99/02045 discloses a process for preparing tomato-based products comprising separating from tomatoes a juice and a slurry, separating the seeds and peels from the slurry, finely dividing the separated slurry and reincorporating the divided slurry into the juice. Tomatoes are heated, e.g., at 65 to 90° C. for cold break or above 90° C. for hot break.

Wagner et al., U.S. Pat. No. 3,892,877 discloses a process for preparing tomato juice of high consistency. Among the steps are extraction of a juice from an acidified macerate and homogenization of the juice by applying vigorous and repeated shearing action. By splitting the produce stream from a single production line, it is said, the operator can homogenize an appropriate proportion and then re-combine it with non-homogenized portion to yield a composite product of improved consistency which has the texture and granular appearance of non-homogenized products but which is less subject to syneresis. In examples, homogenization is in a blender at high speed. Hot macerate is held at 200° F. for a period of time.

### SUMMARY OF THE INVENTION

The present invention is directed to the discovery that the benefits of split stream processing can be more fully realized when the split streams are re-combined under specific processing conditions. In particular, under specified conditions of shear and heat, the potential viscosity of the thick stream is fully harvested. The amount of shear used in accordance with the invention is significantly greater than the amount required to reconstitute at least some prior pastes.

For a more complete of the above and other features and advantages of the invention, reference should be made to the following description of the preferred embodiment.

In accordance with the invention, recombination of the thick and thin streams under the conditions of the invention permits formation of a thicker paste than would have been expected. Thus, either a thicker paste product results, or, the thicker paste can be diluted, thereby conserving resources and minimizing cost to the consumer. If desired, in accordance with the invention a paste can be produced having tomato soluble solids level reductions of up to 20%, especially from 5 to 10% with little or no reduction in Bostwick viscosity. The invention thus permits manufacture of a thicker product from the re-combined stream while the enhanced flavor of split stream processed products are obtained.

In accordance with a preferred aspect of the invention, the streams are recombined in an amount of approximately 90% of the normal recombination amount for the thick stream and 75% of the normal amount for the thin stream. Use of lower amounts of the streams relative to normal recombination ratios makes available more water for hydration and preserves tomato resources. It is expected that beneficial results will be obtained when the amounts range from 60 to 100% of the normal amount for the thick steam and from 40 to 100% of the normal amount for the thick stream.

Preferably, the thick and thin streams are recombined and subject to shear in a first step. In one or more subsequent steps, then, the recombined and sheared streams are again sheared and are heated. In the first shearing step, the re-combined streams are preferably subjected to shear in the range of from 150 sec-1 to 1000 sec-1, especially from 300 sec-1 to 600 sec-1. The heating step involves subjecting the recombined stream, preferably before or during shearing, to temperatures of from at least 130° F. to 212° F., especially from 145° F. to 165° F.

### DETAILED DESCRIPTION OF THE INVENTION

Tomatoes are processed by conventional means such as by crushing, removing seeds and stems, subjecting to a heat treatment, separating the crushed tomatoes into serum (thin stream) and pulp (thick stream). Thin stream will be characterized by a high content of soluble tomato solids, with a Brix range of between 10-50 but more preferably 25-40 Brix. This portion could be called the flavor rich stream since the flavor and volatile components are typically contained within this stream. Thick stream will be characterized by a high content of insoluble tomato solids. The stream typically has a Brix in the range of 4-10, most preferably 5-6. The insoluble solids contained therein include the high molecular weight solids related to the cell wall structure and pectinaceous materials.

Separation can be effected by means known in the art, e.g., using a decanter or a centrifugal separator. The thick stream can be concentrated as in a drier. The thin stream can be concentrated by removing a portion of water using an evaporator such as a thin film or juice evaporator.

The thick and thin streams are recombined to produce a tomato paste. Re-combining can be performed using a combiner or combination unit. Examples include a positive displacement pump and an in-line static mixer.

In accordance with preferred aspects of the invention, the thin and thick streams are subjected to shear, at or after combination, at a level of 150 sec-1 to 1000 sec-1, especially from 300 sec-1 to 600 sec-1. In addition, the re-combined streams are heated to a temperature of at least 130° F., especially from 145° F. to 165° F. The recombined streams can be used to produce a thicker pasta sauce or can be diluted to conserve resources and provide a sauce of comparable thickness but using less resource and soluble solids.

Shear is preferably measured as described in “Transport Phenomena,” Page 62, Problem 2E, Bird, Stewart, Lightfoot. Wiley, 1960.

### EXAMPLE 1

A predetermined weight of thin stream (2078 lbs.) having a Brix of 40 is metered into a Langley tank. The Langley tank has a Silverson mixer installed on its recirculation loop. A Langley tank has a double helix mixer at the bottom with the outlet in the center of the vessel. Then one tote (approximately 2635 lbs) of thick stream is added into the Langley tank and 361 lbs of water at 180-205° F. are added as well to aid dispersion. The double helix mixes the paste and water into a pumpable mix until it is fed to a standardization tank. With the Silverson mixer on, and while the thick stream is being added to the thin stream in the Langley tank, the mixture is also being recirculated through the Silverson.

The recombined stream is then heated in a jacketed tank. The thickened puree created is now added to the batch kettle at the proper formula weight to produce a finished red sauce. It is processed in similar manner to products using conventional paste.

A sauce having improved flavor and texture is obtained relative to traditionally processed red pasta sauces.

### EXAMPLE 2

Using the procedure of Example 1, three batches of red pasta sauce are made. Brix, Bostwick and split stream ratios are given below:

| Batch | Brix | Bostwick | Split Str Ratio | Thin Stream Brix |
|---|---|---|---|---|
| 1 | 12.8 | 6.8 | 100/100 | 40 |
| 2 | 11.5 | 8.2 | 90/90 | 40 |
| 3 | 11.0 | 8.2 | 90/75 | 40 |

### EXAMPLE 3

Using the procedure of example 1, three test batches using thin stream paste with a Brix of 50 are made with the following results:

| | | | | | Additional | |
|---|---|---|---|---|---|---|
| NTSS LEVEL** | | Lbs. Puree* | Brix | Bostwick | Water | |
| 80% | TEST 1 | 3071 | 10.2 | 11.5 | | |
| | | 3371 | 10.6 | 10.8 | +300 | lbs. |
| 85% | TEST 2 | 3264 | 10.4 | 10.2 | | |
| | | 3564 | 10.7 | 9.0 | +300 | lbs. |
| 90% | TEST 3 | 3449 | 10.8 | 9.0 | | |
| | | 3629 | 11.1 | 9.0 | +180 | lbs. |
| 90% | prod | 3585 | 11.7 | 7.7-8.4 | 474 | gal water |

*Note: Lbs. Puree are at a Brix of 17.6
**NTSS = Natural Tomato Soluble Solids

The thickened puree produced by this procedure allows production of finished product with natural tomato soluble solids (NTSS) reduced by over 15% from the formula weight but still within the acceptable range of the Bostwick specification of 8-10 cm for that particular product. With a 10% reduction in natural tomato soluble solids from the formula weight using conventional paste and processing, the Bostwick remains comfortably within the range of 8-10 cm for the product.

It should be understood of course that the specific forms of the invention herein illustrated and described are intended to be representative only, as certain changes may be made therein without departing from the clear teaching of the disclosure. Accordingly, reference should be made to the appended claims in determining the full scope.

1. A process of preparing a tomato product comprising re-combining thick and thin streams and subjecting the re-combined streams at a temperature of at least 150° F. to shear of from 150 sec-1 to 1000 sec-1.

2. The process according to claim 1 further comprising subjecting the sheared, re-combined streams to a further shear step of from 150 sec-1 to 1000 sec-1.

3. The process according to claim 1 further comprising subjecting the re-combined streams to heating to a temperature of at least 150° F. during the shear step.

4. The process according to claim 3 wherein said re-combined stream are heated to 150° F. before being subjected to shear of from 150 sec-1 to 1000 sec-1.

5. The process according to claim 2 further comprising subjecting the sheared, re-combined streams to heating to a temperature of at least 150° F.

6. A process of making a tomato product comprising crushing tomatoes, to form a stream, separating the stream into thick and thin substreams, re-combining the thick and thin substreams into a recombined stream and subjecting said recombined stream to at least 150 sec-1 of shear while said recombined steam is at a temperature of at least 130° F.

7. The process according to claim 6 wherein said recombined stream is subjected to from 150 sec-1 to 1000 sec-1 of shear.

8. The process according to claim 6 wherein said recombined and sheared stream is heated to a temperature of at least 150° F.

9. The process according to claim 6 wherein said recombined and sheared stream is subjected to a further shearing step in which it is subjected to from 150 sec-1 to 1000 sec-1 of shear.

10. The process according to claim 9 wherein prior to the first shearing step, the recombined stream is heated above 130° F.

11. The process according to claim 10 wherein prior to the first shearing step the recombined stream is heated to 145° F. or above.
